(19) United States
(12) Patent Application Publication
(10) Pub. No.: US 2010/0318729 A1
(43) Pub. Date: Dec. 16, 2010

(54) NONVOLATILE SEMICONDUCTOR MEMORY DEVICE

(75) Inventor: Toshihiko HIMENO, Kanagawa-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/795,112

(22) Filed: Jun. 7, 2010

(30) Foreign Application Priority Data
Jun. 11, 2009 (JP) 2009-139941

(51) Int. Cl. G06F 12/00; G06F 12/02

(52) U.S. Cl. 711/103; 711/E12.001; 711/E12.008

(57) ABSTRACT

A NAND type flash memory having a program verifying function is provided, which can search for stored data at high speed. The flash memory reads search data that corresponds to stored data stored in a block in a front page of the block in a reverse-order search mode, compares the search data with the non-search data from a controller, and returns a block address and a page address of the search data that matches with the non-search data to the controller. At this time, the flash memory checks the match between the search data and the non-search data by comparing “0” data using the program verifying function provided in the flash memory itself.

### CROSS-REFERENCE TO RELATED APPLICATION

This application is based upon and claims the benefit of priority from the prior Japanese Patent Application No. 2009-139941, filed on Jun. 11, 2009, the entire contents of which are incorporated herein by reference.

### BACKGROUND OF THE INVENTION

The present invention relates to a nonvolatile semiconductor memory device, and for example, relates to a NAND type flash memory having a write (program) verify function. More particularly, the present invention relates to a nonvolatile semiconductor memory device which can search for stored data at high speed using existing functions and can reduce the load on an external device.

A nonvolatile semiconductor memory device, which is represented by a flash memory, has increased in memory capacity every year, and in a personal computer, it has become an important storage medium alongside hard discs. Particularly, in mobile devices such as portable phones or the like, it has become an essential device as a large-capacity storage medium. However, with the increase of a memory capacity, a long time is needed when searching for stored data, and this causes a serious problem for improving the performance of the whole system such as a personal computer, a portable phone, or the like.

In the case of searching for stored data in a flash memory in the related art, an external controller simply reads all of the stored data and judges which stored data satisfy a search condition through comparison of the whole stored data to the search condition by the controller. In this case, it takes time to perform the search in proportion to the memory capacity. Also, since the controller controls the read operation, it may be impossible to read, write, or erase other data during the search period, and this places a burden on the whole system.

In order to avoid this problem, there is a system for a software avoidance scheme that reserves a storage location (storage), which is for pre-storing data as a pointer in a specified small-capacity region in a flash memory. In this system, since the storage location of desired stored data can be easily found by searching only the specified small-capacity region, search time can be greatly reduced, and thus the time the controller is occupied can be shortened by the same amount. However, this system has the problem that the search cannot be performed unless the format of the pre-stored data is clear and the stored data can only be judged by the contents that can be written in the small-capacity region. Since this problem is fatal to a flash memory in which the stored data from diverse systems or software may be written, this method is unusable for general purposes.

As described above, with the recent trend towards large memory capacity, there is a need for a function capable of searching for the storage of the stored data at high speed.

### BRIEF SUMMARY OF THE INVENTION

The present invention can provide a nonvolatile semiconductor memory device which can search for stored data at high speed using an existing function and can reduce the load on an external device.

According to a aspect of the invention, there is provided a nonvolatile semiconductor memory device in a memory circuit comprising: a memory cell array for storing data; an address stored circuit capable of indicating an arbitrary storage location in the memory cell array; a read circuit reading stored data from the storage location corresponding to an address that is maintained by the address stored circuit; a first temporary storage means for reading and maintaining stored data from the memory cell array; a second temporary storage means for storing search data; an operation circuit capable of operating the contents of the two storage means through one-to-one comparison of the contents for each bit; and a memory address updating means for reading the contents of the address stored circuit when the stored data stored in the first temporary storage means is read from the memory circuit if the contents match with each other as the result of comparison, and repeating tasks for updating the contents of the address stored circuit when the data are read from the first temporary storage means, reading again data of another address from the first temporary storage means, and comparing the contents of the first and second temporary storage means if the contents do not match with each other as the result of comparison.

### BRIEF DESCRIPTION OF THE DRAWINGS

FIG. 1 is a block diagram illustrating a configuration example of a nonvolatile semiconductor memory device (e.g. a NAND type flash memory) according to a first embodiment of the present invention;

FIG. 2 is a circuit diagram illustrating a configuration example of a NAND cell string in a memory cell array of a NAND type flash memory;

FIG. 3 is a flowchart illustrating an operation example of a NAND type flash memory in a reverse-order search mode;

FIG. 4 is a flowchart illustrating another operation example of a NAND type flash memory in a reverse-order search mode;

FIG. 5 is a flowchart illustrating still another operation example of a NAND type flash memory in a reverse-order search mode;

FIG. 6 is a diagram illustrating a threshold value distribution in an eight-bit mode;

FIG. 7 is a diagram illustrating a threshold value distribution in a binary mode;

FIG. 8 is a threshold value distribution diagram illustrating an example of binary storage in an eight-bit mode; and

FIG. 9 is a threshold value distribution diagram illustrating another example of binary storage in an eight-bit mode.

### DETAILED DESCRIPTION OF THE INVENTION

Hereinafter, preferred embodiments of the present invention will be described in detail with reference to the accompanying drawings. However, drawings are schematic, and it should be noted that in the drawings, sizes, rates, and the like, differ from those in reality. Also, in the related drawings, portions having different dimensional relations and/or rates are necessarily included. Particularly, in some embodiments described hereinafter, an apparatus and a method for embodying the technical features of the present invention are exemplified. However, the technical features of the present invention are not specified by the shapes, structures, arrangements, or the like of the constituent components. Various modifications can be made with respect to the technical features of the invention without departing from the scope of the present invention.

### First Embodiment

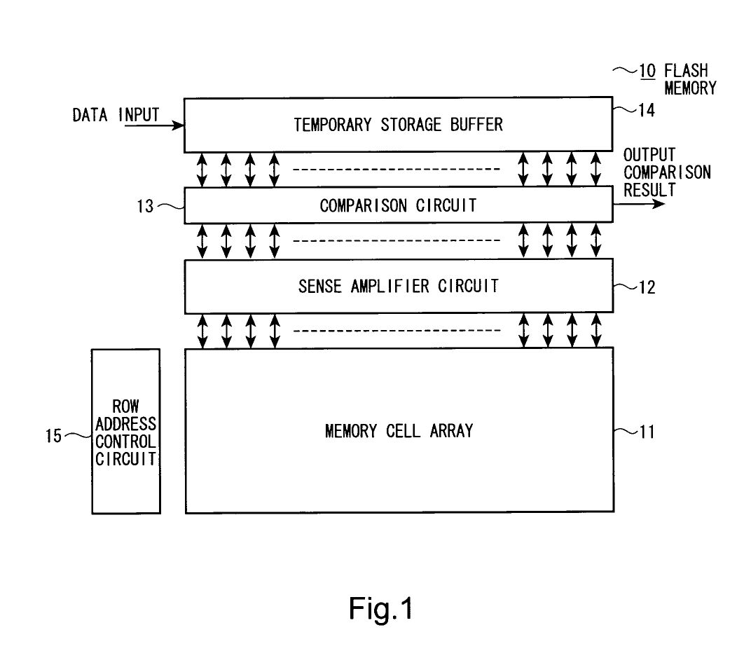

FIG. 1 illustrates a basic configuration of a nonvolatile semiconductor memory device according to a first embodiment of the present invention. In the embodiment of the present invention, a NAND type flash memory having a program verifying function is exemplified. In this case, only the main portions of the chip are illustrated, and other portions thereof will be omitted from the illustration.

As illustrated in FIG. 1, in a flash memory 10, a memory cell array 11, a sense amplifier circuit 12, a comparison circuit 13, a temporary storage buffer (i.e. data buffer) 14, a row address control circuit 15, and the like, are installed. In the flash memory 10, an existing program verifying function for determining whether a write operation has been completed through the sense amplifier circuit 12, the comparison circuit 13, and the temporary storage buffer 14 is realized.

The memory cell array 11 has a plurality of NAND cells (i.e. memory cell transistors composed of MOS (Metal Oxide Semiconductor) transistors having a double (laminated) gate structure), and stores in a nonvolatile manner binary data, eight or more-bit data, or multi-bit data of more than three bits for each cell transistor.

The sense amplifier circuit 12 has a plurality of sense amplifiers S/A installed for bit lines of the memory cell array 11, and senses search data that corresponds to stored data written in the cell transistors in a selected state (hereinafter referred to as a “selected cells”), for example, in a reverse-order search mode.

The comparison circuit 13 compares (i.e. performs EXOR operation of) an output of the sense amplifier circuit 12 and an output of the temporary storage buffer 14 in the unit of bit lines, and outputs the result of comparison (i.e. OR output). For example, in a reverse-order search mode, the comparison circuit 13 checks the match between non-search data and search data.

The temporary storage buffer 14 is an internal buffer for maintaining written data for one page input from an external device (e.g. a controller) (not illustrated), and temporarily stores non-search data that corresponds to desired stored data to be searched for, for example, in a reverse-order search mode.

In the embodiment of the present invention, the term “reverse-order search mode” means a function (i.e. process) of searching for a storage location (i.e. storage) on the memory cell array 11 of stored data, which corresponds to, for example, non-search data such as dates or the like and search data, respectively, with respect to a typical search mode for reading the stored data on the memory cell array 11 that corresponds to a search condition.

The row address control circuit 15 selects a block which corresponds to a block selection signal from the memory cell array 11, and supplies an appropriate voltage according to the operation to word lines and a selection signal line of the selected block.

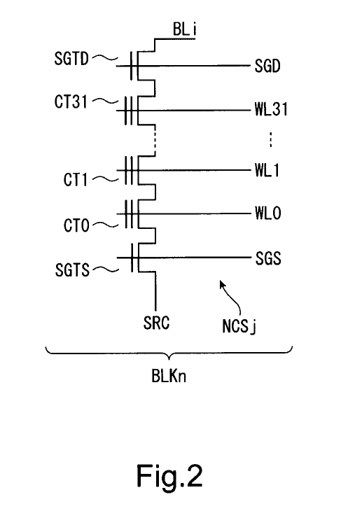

Here, the configuration of the memory cell array 11 will be simply described. In the embodiment of the present invention, for example, as illustrated in FIG. 2, a NAND cell string NCSj is constituted by m (e.g. 32) cell transistors CT0 to CT31 connected in series and two selection transistors SGTD and SGTS connected to both ends thereof. The NAND cell string NCSj is a configuration unit of the memory cell array 11. Each of the cell transistors CT0 to CT31 is composed of a MOS transistor having a double-gate structure that includes a control gate electrode and a floating gate electrode. Word lines WL0 to WL31 are connected to the control gate electrodes of the cell transistors CT0 to CT31, respectively. One selection transistor SGTD at one end of the NAND cell string NCSj is connected to any one of bit lines BLi. A selection signal line SGD is commonly connected to the gate electrode of the selection transistor SGTD. The other selection transistor SGTS at the other end of the NAND cell string NCSj is commonly connected to a cell source line SRC. A selection signal line SGS is commonly connected to the gate electrode of the selection transistor SGTS. The word lines WL0 to WL31 and the selection signal lines SGD and SGS are connected to the row address control circuit 15, respectively. The bit lines BLi are connected to S/A of the sense amplifier circuit 12.

In the embodiment of the present invention, a block (one unit) BLKn is configured by j NAND cell strings NCS which share the word lines WL0 to WL31 and the selection signal lines SGD and SGS. That is, n blocks BLK are installed in the memory cell array 11, and j NAND cell strings NCS, which are connected to different bit lines BLi, are installed in each block BLKn. Also, j NAND cell strings NCS of each block BLKn share the word lines WL0 to WL31 and the selection signal lines SGD and SGS. In each block BLKn, each unit of the cell transistors CT0 to CT31, which share the word lines WL0 to WL31, becomes a “page”.

For example, search data which correspond to stored data are stored in a front page of the block BLKn in which the stored data are stored. Also, the search data which correspond to the stored data are stored in a front page of a data region in which the stored data are stored.

In this case, the data write and erase is performed by passing electrons in and out with respect to the floating gate electrodes of the selected memory cell transistors CT0 to CT31 using FN tunnel current. Typically, it is assumed that a state in which electrons are injected into the floating gate electrode corresponds to writing “0”, and a state in which electrons are not injected into the floating gate electrode corresponds to writing “1” (erase). Also, written data are written to the cell transistors CT0 to CT31 to be stored data, and the stored data are read by the cell transistors CT0 to CT31 to be read data.

Next, with the above-described configuration, an operation in a reverse-order search mode using a program verifying function will be described.

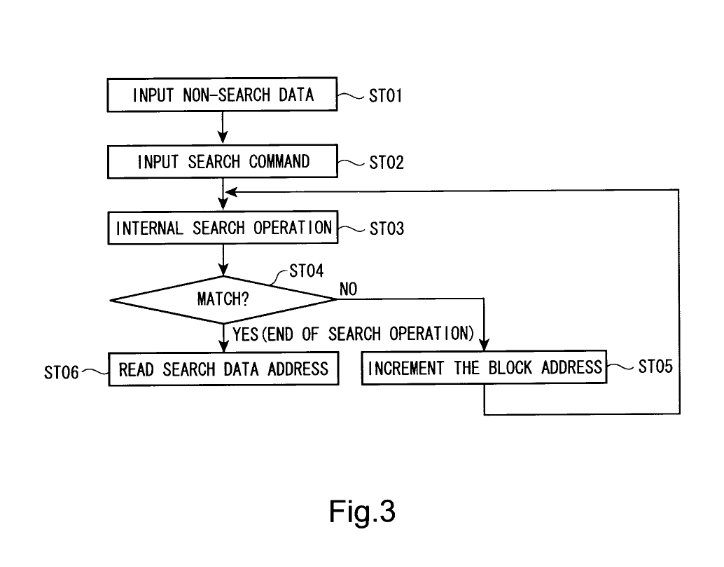

FIG. 3 illustrates a flow of process in a reverse-order search mode. For example, in a reverse-order search mode, a user inputs non-search data which correspond to desired stored data that the user intends to search for in the same manner as the input of written data through an external controller (step ST01). The input non-search data are stored in a temporary storage buffer 14 that is in one-to-one correspondence to each bit line BLi.

In this case, as the search data of the stored data (Don't Care) that are not desired to be searched for, for example, “1” data are written. This is an operation for confirming that the program verifying function corresponds to “0” data, and by writing “1” data, it is possible to exclude the stored data except for the desired stored data from the subject of search. Also, even when the read operation is interrupted midway, the corresponding data can be excluded from the subject of search in the same manner as the case where “1” data has been written. Also, in the same manner, even in the case where the input of the non-search data starts in the midst of the address to be searched for, “1” is loaded as the search data that corresponds to the address prior to the input.

If the input of the non-search data is completed, the user then inputs a search command through the controller (step ST02).

As the search command is input, the flash memory 10 starts the internal search operation (step ST03). The search operation is controlled by the row address control circuit 15, and the reading of search data from the designated search start block address and the page address is performed. If the address to be searched for has not been designated, the reading of the search data from the front block address of the memory cell array 11 and the page address is performed. The read search data are stored in the S/A of the sense amplifier circuit 12 connected for each bit line BLi.

The comparison circuit 13 examines the data match by comparing the non-search data stored in the temporary storage buffer 14 and the search data in the sense amplifier circuit 12 (step ST04). For example, the result of an OR operation for the whole bit lines BLi is obtained from the result of EXOR operation for each bit line BLi, and it is checked whether the search data and the non-search data match with each other for all the bit lines BLi.

In this case, the above-described operations are prepared in advance as functions of realizing the program verifying through the NAND type flash memory 10. Since it is not necessary to add any new circuit, there is no increase of costs.

If the search data and the non-search data do not match with each other as the result of comparison, the above-described processes (steps ST03 and ST04) are repeated by incrementing the block address or the page address within the addresses to be searched for or the addresses up to the maximum block address (step ST05).

If the search data and the non-search data match with each other as the result of comparison, the flash memory 10 stops the search operation, and notifies the controller of the result using a ready/busy signal. The controller, having received the notification, can recognize the address of the storage of the corresponding stored data by reading the block address and the page address on the memory cell array 11 from the flash memory 10 of the match search data as the result of comparison from the flash memory 10 (step ST06).

As described above, by efficiently using the program verifying function typically provided in the NAND type flash memory, the search of the stored data becomes possible at high speed and with small load on the controller. That is, in the reverse-order search mode function for searching the storage of the stored data, the “0” data match between the search data corresponding to stored data and the non-search data are checked by the program verifying function, and thus the stored data can be searched inside the flash memory. Accordingly, an unnecessary load is prevented from being imposed on the external controller, and a high-speed search for the stored data becomes possible. Further, as the circuit originally provided in the flash memory is used as it is, a search method that is appropriate to the flash memory can be obtained without the necessity of circuit addition or the like.

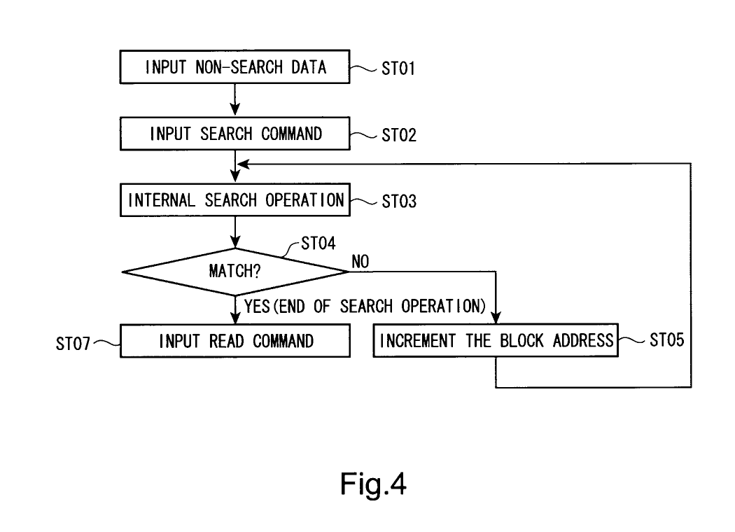

In the above-described embodiment, it is exemplified that the controller read the search data address. However, the read operation is not limited thereto. For example, as illustrated in FIG. 4, since the end of the search operation (step ST06) means that desired stored data that corresponds to the non-search data has been found, it is also possible to automatically read the stored data of an address that follows the search data address (step ST07). That is, by performing a read operation in accordance with the input of a read command, without re-inputting the read block address and page address, the search data and the stored data that corresponds to the search data can be automatically read.

Also, if the data match with each other as the result of comparison, it is also effective to temporarily store the block address and the page address at that time in the internal storage circuit (not illustrated) and to continue the search operation. If the search data that matches with the non-search data are not limited to “1”, it is also possible to perform the reading with the addresses of the match search data added by repeating a series of processes up to the end address of the addresses to be search. In this case, the number of match search data is limited by the capacity of the prepared temporary storage buffer 14.

Also, if the above-described match search data are not limited to “1”, effective search operation can be realized by ending the search operation (and reading the address as the result of search) whenever the non-search data and the search data match with each other. That is, if the search data and the non-search data match with each other, the corresponding state is notified to the controller by a ready/busy signal, and the controller, having received the notification, reads the block address and the page address on the memory cell array 11 of the search data from the flash memory 10, and makes the flash memory 10 continue the search operation using, for example, the search command. Accordingly, it is possible to automatically continue the search operation without re-inputting the non-search data and the address to be searched.

The controller can judge of the search operation is in progress or has ended through confirming the search data address. Accordingly, in this embodiment, by continuously making a search command different from a typical search command, it is possible to determine whether to start the search operation from the front address of the memory cell array 11 even though the search start address is not input.

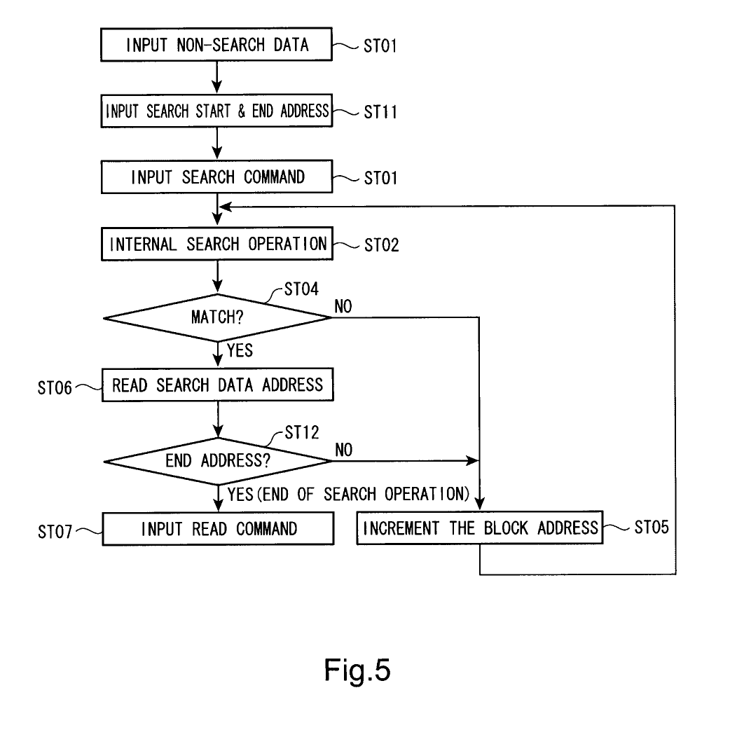

In this case, if the processing is complicated due to the use of a plurality of commands, for example, if the search start address is not input, either the block address buffer or the page address buffer becomes a general purpose buffer so that the search operation starts from the addresses existing in the block address buffer and the page address buffer (not illustrated). Accordingly, if the search operation is intended to start from a desired address, especially, if it is intended to start from the front address of the memory cell array 11, it is also effective to request the input of the address to be searched that designates the range of addresses to be searched from the user. That is, as illustrated in steps ST11 and ST12 of FIG. 5, more efficient search operation can be realized by limiting the range of the addresses to be searched through the input of the search start address and end address.

Also, the input of the search command may accompany the input of the search start column address. If the search start column address is input, the flash memory 10 starts the search operation from the column that corresponds to the address. A column that corresponds to an address prior to the address corresponds to the same state in which “1” is loaded, and thus it does not become the subject of search operation.

Also, the input of the search command may accompany the input of the search start block address. If the search start block address is input, the flash memory 10 starts the search operation from the block that corresponds to the address, and continues the search operation as automatically incrementing the block address.

Also, the input of the search command may accompany the input of the search end block address. If the search end block address is input, the flash memory 10 ends the search operation at the block of the address. If the search end block address is not input, the memory cell array 11 continues the processing until the search operation of the block of the maximum block address is ended.

Also, in the case of updating the address by incrementing the block address and the page address (each step ST05 in FIGS. 3, 4, and 5), it is also effective to increase a predetermined amount of address in addition to the increase of the address one by one. For example, in the case of storing the search data in each front page of the data region that is obtained by dividing the memory cell array 11 into 64 blocks, the search data can be reduced as much as the amount of 64×page size, and thus the search operation can be performed at higher speed. In this case, it may be determined that the block address is increased by one address for 64 blocks after the page address is fixed.

### Second Embodiment

According to the second embodiment of the present invention, in a reverse-order search mode, the match between the non-search data and the search data are checked by comparing “0” data and “1” data of the non-search data and the search data. That is, in the case of the first embodiment in which only “0” data of the non-search data and the search data are compared, there is a possibility that even the non-match search data are determined to match with each other due to an erroneous result of comparison.

Accordingly, in the second embodiment, the non-search data and its reverse data are input to improve the accuracy of the search operation (reverse-order search mode function). For example, in the reverse-order search mode, the reverse data of the non-search data are input after the non-search data are input. In this case, regarding the stored data (column) which is desired to be excluded from the subject of search, “1” data are input in the same manner as the first embodiment. That is, the stored data, for which “1” data are input together with the non-search data and the reverse data, is excluded from the subject of search.

The flash memory 10 is provided with a buffer (data latch) (not illustrated) for storing the reverse data, separately from the temporary storage buffer 14 for storing the non-search data, in addition to the above-described configuration as illustrated in FIG. 1.

In the flash memory 10, for example, through the same process as that in the first embodiment, the search data of which the results of comparison through the comparison circuit 13 match with each other are searched for in the memory cell array 11. In this case, reverse reading of the search data, of which the results of comparison match with each other, is performed, and through the comparison circuit 13, the reverse read data read by the sense amplifier circuit 12 is compared with the reverse data in the data latch. In this case, in the same manner as the comparison of the non-search data, which is the non-reverse data, with the search data, the program verifying function provided in the flash memory 10 performs only the comparison of “0” data, and thus the results of comparison of the stored data, which are not the subject of search, match with each other regardless of whether the reverse read data are “0” data or “1” data.

Since the subsequent processes are the same as those as described above according to the first embodiment of the present invention, the detailed description thereof will be omitted.

As described above, with a simple change of specifications, that is, with the addition of the data latch for storing the reverse data only, both “0” data and “1” data can be compared. Accordingly, the high-speed search for the stored data are not injured in the case where the reverse search is performed using the typical program verifying function already provided in the flash memory, and the accuracy of the search operation can be improved with the reduction of the load on the controller. Also, since the comparison of the reverse data with the reverse read data is performed only when the non-search data and the search data match with each other, it is effective to suppress the impact against the time for the search operation in the case where the frequency in data match is low.

Although the flash memory 10 having the configuration as illustrated in FIG. 1 requires the addition of the data latch for storing the reverse data, a flash memory which has a plurality of built-in data latches for each column, for example, a flash memory that stores multi-bit data, can store the reverse data by effectively using the data latch already provided therein, without the addition of a new circuit.

### Third Embodiment

According to the third embodiment of the present invention, in a reverse-order search mode, mask data for discriminating between a column of the subject of search and a column of the subject of non-search is loaded in accordance with the non-search data. In this embodiment, the search data are stored in the front address of each column.

For example, if the flash memory 10 has a tool for excluding an inferior column from the subject of program verifying function, the column except for the column that is the desired subject of search can be excluded from the subject of search at higher speed, and thus a high-accuracy search operation (in the reverse-order search mode) can be realized. That is, in the case where an inferior column exists in the memory cell array 11, the flash memory may be provided with a tool for replacing a column redundancy circuit and a typical memory circuit and a tool for disregarding the inferior column to realize the blanket verifying function. Although various tools may be provided to achieve the above-described function, their basic functions are the same. That is, a data latch (not illustrated) for storing data for indicating whether the column is a normal column or an inferior column is provided, and the column indicated by the data are excluded from the subject of verifying.

In the third embodiment of the present invention, the column, which should be excluded from the subject of search, is set using the data latch for storing the data that indicates the inferior column. For example, in the reverse-order search mode, the controller reads the replacement data which indicates the inferior column that is stored in the data latch and stored the replacement data until a search command is input. Thereafter, if the search command is input, the controller resets the data latch to determine all columns as columns which are excluded from the subject of search, and then set the column that is the subject of search in the data latch in accordance with the non-search data input at the time when the non-search data are input to discriminate between the column that is the subject of search and the column that is the subject of non-search. That is, it is possible to set only the column that corresponds to the non-search data as the column that is the subject of search.

Thereafter, in the order as described above according to the first embodiment of the present invention, the comparison of “0” data in the non-search data and the search data is performed, and then the comparison of “1” data is performed by comparing the reverse read data with the reverse data of the non-search data. At this time, the search data of the column that is excluded from the subject of search, except for the column that is set in the data latch, are not compared, and thus a high-speed and high-accuracy search operation can be performed.

In the third embodiment of the present invention, the data latch is of the same type (standard) as that of the temporary storage buffer 14 as stated in the first embodiment, and provides effective technology even in the case where the flash memory is not a flash memory that stores multi-bit data.

Also, in the third embodiment of the present invention, at the time point when the search operation is ended, the controller resets the replacement data which indicates the inferior column that is pre-stored in the data latch, and returns the flash memory 10 to a state before the search operation is performed to end the reverse-order search mode. However, in the case of a flash memory that stores the replacement data of the inferior column in another data region, it is not necessary to pre-store the replacement data through the controller.

As described above, by effectively using the program verifying function that has been typically proved in the NAND type flash memory, the stored data can be searched at high speed using only the memory chip, without depending upon the external controller, and thus an appropriate search function can be achieved in the flash memory.

Next, the reverse-order search mode function which is realized in a flash memory (hereinafter referred to as a “multi-bit memory”) that stores multi-bit data will be considered.

In the case of a multi-bit memory, it is possible to maintain the search data as multi-bit data in the same manner as the typical stored data. However, in consideration of the characteristics of the search data which require greater reliability, a method of maintaining the search data in a binary mode in distinction from other stored data is considered. However, in the case of a flash memory having a function of storing data in a multi-bit mode, the threshold values of the cell transistors can be controlled with better accuracy through storing of the data in the multi-bit mode, and thus this function is actively used to realize the search operation (reverse-order search mode function) having a high reliability.

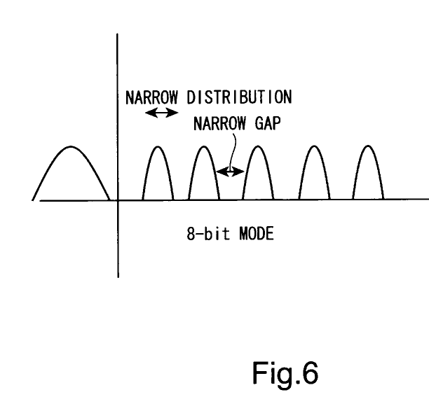

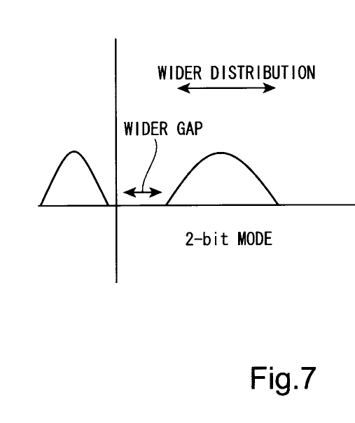

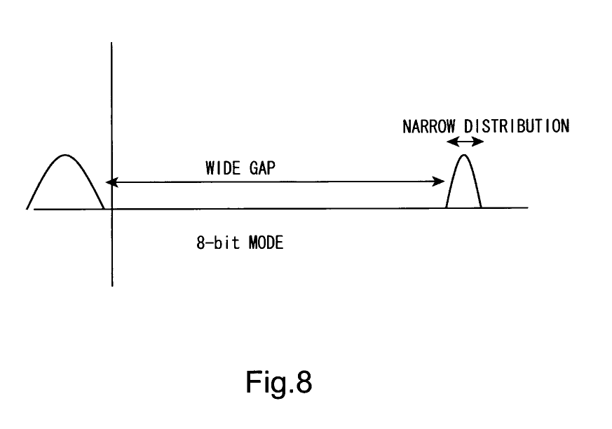

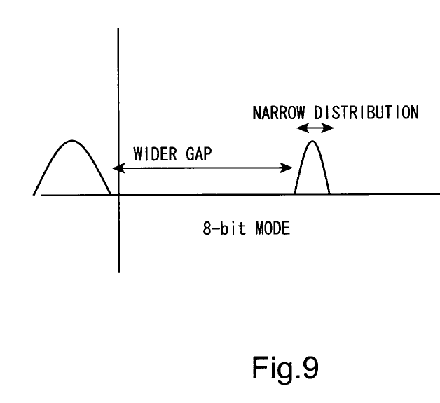

For example, as illustrated in FIG. 6, in the case of a flash memory that can store data in an eight-bit mode, the threshold value of the cell transistor can be controlled in eight regions (distribution), but it is difficult to secure the reliability since the gap between the respective distributions is narrow. Accordingly, as illustrated in FIG. 7, by storing the binary data using the threshold distribution of the eight-bit mode, a higher reliability can be secured. In this case, for example, as illustrate in FIG. 8, if the threshold value is set to be unnecessarily high, the reliability may be lowered. Due to this, in the case of the search data, for example, as illustrated in FIG. 9, it is preferable to store the data using the threshold value distribution of an intermediate level in the eight-bit mode.

Next, application of the above-described reverse-order search mode function in a system that is configured using a plurality of memory chips will be considered.

The nonvolatile semiconductor memory device such as the NAND type flash memory has various uses in a system composed of a plurality of chips in addition to the use in a single chip. Particularly, in the case of a large-capacity system, a system is configured using a plurality of memory chips.

In this system, a controller typically controls the whole system to perform the search operation. However, as described above, by making the search operation (reverse-order search mode function) possible in the memory chip, it becomes possible to perform the search operation in parallel for each packaged memory chip. As the number of memory chips increases in the system, the search efficiency becomes improved. Accordingly, the above-described reverse-order search mode function is actually effective as a high-speed search method in a large-scale system.

In addition, the present invention is not limited to the above-described embodiment(s), and in practical applications, various modifications are possible, without departing from the scope of the invention. Further, the above-described embodiment (s) can include invention of various steps, and thus various inventions can be extracted through an appropriate combination of plural configuration conditions as described above. For example, even though some configuration conditions are erased from the whole configuration conditions as indicated in the embodiment(s), (at least one of) the above-described technical subjects can be solved. Also, in the case where (at least one of) the above-described effects can be obtained, the configuration from which the corresponding configuration condition is erased can be extracted as the invention.

What is claimed is:

1. A nonvolatile semiconductor memory device in a memory circuit comprising:
a memory cell array for storing data;
an address stored circuit capable of indicating an arbitrary storage location in the memory cell array;
a read circuit reading stored data from the storage location corresponding to an address that is maintained by the address stored circuit;
a first temporary storage means for reading and maintaining stored data from the memory cell array;
a second temporary storage means for storing search data;
an operation circuit capable of operating the contents of the two storage means through one-to-one comparison of the contents for each bit; and
a memory address updating means for reading the contents of the address stored circuit when the stored data stored in the first temporary storage means is read from the memory circuit if the contents match with each other as the result of comparison, and repeating tasks for updating the contents of the address stored circuit when the data are read from the first temporary storage means, reading again data of another address from the first temporary storage means, and comparing the contents of the first and second temporary storage means if the contents do not match with each other as the result of comparison.

2. The nonvolatile semiconductor memory device according to claim 1, further comprising the operation circuit comparing if the first and second temporary storage means completely match with each other considering either of “1” data and “0” data stored in the second temporary storage means as a subject of comparison when digital information that is indicated by a binary number of “1” or “0” is stored.

3. The nonvolatile semiconductor memory device according to claim 1, further comprising the operation circuit comparing if the first and second temporary storage means completely match with each other with considering both “1” data and “0” data stored in the second temporary storage means as a subject of comparison when digital information that is indicated by a binary number of “1” or “0” is stored.

4. The nonvolatile semiconductor memory device according to claim 1, wherein only a predetermined address is increased when the contents of the address stored circuit are updated.

5. The nonvolatile semiconductor memory device according to claim 1, wherein only a predetermined address is decreased when the contents of the address stored circuit are updated.

6. The nonvolatile semiconductor memory device according to claim 1, wherein the operation circuit has a means for fixing the each bit comparison result to “match” status to ignore the bits from the bit by bit comparison, and excludes the pre-designated bit from the subject of comparison using the means.

7. The nonvolatile semiconductor memory device according to claim 1, further comprising a third temporary storage means for storing the contents of the address stored circuit when the data of the second temporary storage means is read if the data of the first and second temporary storage means match with each other as the result of comparison;
wherein if the data of the first and second temporary storage means match with each other as the result of comparison, the contents of the address stored circuit are stored in the third temporary storage means and then the contents of the address stored circuit are updated, while if the data of the first and second temporary storage means do not match with each other as the result of comparison, the contents of the address stored circuit are updated without storing the contents in the third temporary storage means, the next data are read from the second temporary storage means, and the next comparison operation is repeated; and
wherein the contents of the address stored circuit stored in the third temporary storage means are read after the arrival of the search end address.
